(19) United States
(12) Patent Application Publication
(10) Pub. No.: US 2013/0039410 A1
(43) Pub. Date: Feb. 14, 2013

(54) METHODS AND SYSTEMS FOR ADAPTING ERROR CORRECTING CODES

(71) Applicants: Wai-Tian Tan, Sunnyvale, CA (US); Andrew J. Patti, Cupertino, CA (US); Mitchell Trott, San Mateo, CA (US)

(72) Inventors: Wai-Tian Tan, Sunnyvale, CA (US); Andrew J. Patti, Cupertino, CA (US); Mitchell Trott, San Mateo, CA (US)

(21) Appl. No.: 13/205,389

(22) Filed: Aug. 8, 2011

(51) Int. Cl. H04N 7/64; H04N 7/26; H04B 1/66

(52) U.S. Cl. 375/240.02; 375/240; 375/E07.126; 375/E07.279

(57) ABSTRACT

Methods for adapting the sliding window of sliding window-based error correcting codes based on the coding structure of a compressed media stream are disclosed. In one aspect, a sender packetizes each frame of a media stream to be sent to a receiver into a set of frame packets. The sender also determines compression dependence of each frame and adapts a sliding window of a sliding window-based error correcting code based on the compression dependence of the frame. The sender encodes the frame packets into at least one associated parity packet according to the error correcting code with the adapted sliding window, and sends the frame packets and the at least one associated parity packet to the receiver.

### BACKGROUND

When temporally compressed media, such as video or remote graphics/desktop, is streamed over large distances, such as between the United States and Japan, noise in the transmission channels creates transmission errors in the media stream that may result in the loss of data, such as loss of a complete or a partial video frame, resulting in annoying interruptions when the media stream is displayed. Low delay loss recovery mechanisms, such as those based on error correcting codes, can be used to try and recover the lost frames. However, typical low-delay use of block code-based error correcting codes is ineffective against burst losses, resulting in pauses in the media stream displayed for a viewer. In recent years, error correcting codes based on a “sliding window” have been introduced to recover lost frames with an average shorter delay than the average delay produced by typical block codes. However, sliding window-based error correcting codes also have a few drawbacks. First, a burst loss may cause collapse of the error correcting scheme, rendering future parity packets useless to correct even single packet losses. Second, even if the sliding window is reset after a burst of losses, the earlier losses in the stream may corrupt later frames even if the later frames are received without transmission errors. Third, even though the average delay is typically low for sliding window error correcting codes, the delay resulting from applying typical sliding window-based error correcting codes may still be large enough, on occasion, to produce annoying pauses in the media stream displayed for a viewer. As a result, the media communications industry and those interested in streaming media continue to seek techniques to correct transmission errors in media streams with minimal delay.

### BRIEF DESCRIPTION OF THE DRAWINGS

FIGS. 1A-1B show an example representation of a sender and receiver of video frame packets.

FIG. 2 represents compression and packetization performed by a sender of a video stream.

FIG. 3 shows an example of an adaptable sliding window associated with three consecutive compressed video frames.

FIGS. 4A-4C show examples of mathematical representations of parity packets encoded with an adaptable sliding window using linear generator functions.

FIG. 5 shows a general representation of a generator matrix in which the generator matrices of FIG. 4 are submatrices.

FIGS. 6A-6C show three different examples of generator dependency matrices and an adaptable sliding window for nonlinear generator functions.

FIG. 7 shows a control-flow diagram of an example method for preparing and sending video frame packets from a sender to a receiver.

FIG. 8 shows a control-flow diagram of an example method for processing receive video frame packets.

FIG. 9 shows a schematic representation of an example computing device.

### DETAILED DESCRIPTION

Methods for adapting the sliding window of sliding window-based error correcting codes based on the coding structure of a temporally compressed media stream are disclosed. The methods for adapting the sliding window increase decodability of the media stream and reduce the delay associated with correcting transmission errors.

Methods also include changing the compression structure of the media to further reduce the delay. Although for the sake of brevity methods for adapting a sliding window of a sliding window-based error correcting code are described below with reference to video streams, it should be noted that the same techniques readily apply to other forms of temporally compressed media, such as, but not limited to, remote graphics/desktop and multiplexed transmission of audio and video. Systems for implementing the methods are also disclosed.

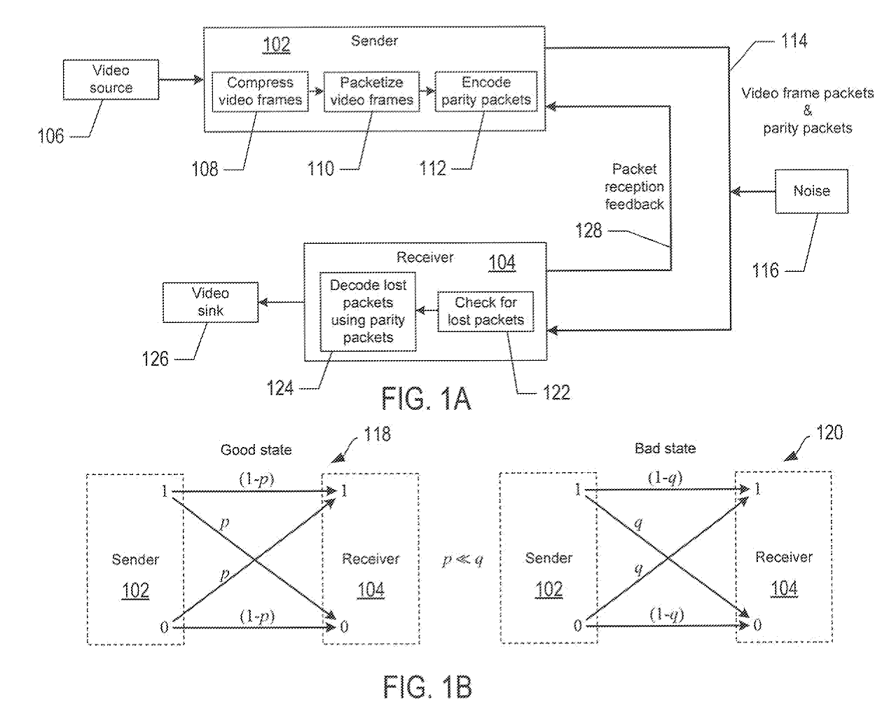

FIG. 1A shows an example of a system for implementing the methods described below. The system includes a sender 102 and a receiver 104. The sender 102 receives a video stream from a video source 106, such as a video stream produced by a video camera or a video stream received over the Internet. The sender 102 performs data compression 108 to compress video frames and packetizes 110 the video frames. The sender 102 uses an adaptable sliding window-based forward error correcting (“FEC”) code to encode parity packets 112 associated with the video frame packets of each video frame and sends the video frame packets and associated parity packets over a data transmission channel 114 to the receiver 104. Methods for compressing 108, packetizing 110, and encoding 112 are described in greater detail below.

The channel 114 may be subject to noise 116 that causes transmission errors in the data sent from the sender 102 to the receiver 104. The noise 116 may be the result of signal fading, impulsive switching noise, crosstalk, and network overload. In one common network model, the channel 114 can be characterized as being in either a “good state” 118 or a “bad state” 120, as shown in the example of FIG. 1B. When the channel 114 is in the good state 118, each bit in a video frame packet or a parity packet has a low probability p (i.e., p≈0) of being incorrectly transmitted from the sender 102 to the receiver 104 and a high probability 1−p of being correctly transmitted from the sender 102 to the receiver 104. On the other hand, when the channel 114 is in the had state 120, each bit in a video frame packet or a parity packet has a higher probability q (e.g., q≈0.5) of being incorrectly transmitted from the sender 102 to the receiver 104. Most of the time the channel 114 is in the good state, but on occasion the channel shifts into the had state due to noise 116. As a result, transmission errors occur in clusters or bursts composed of a contiguous string of bits transmitted in error called a “burst error.” A burst error can be as short as a substring of bits of a packet or as large as several neighboring packets. A packet altered by a burst error is called a “lost packet.”

Returning to FIG. 1A, the receiver 104 receives the video frame packets and associated parity packets and checks 122 for lost packets. When lost packets are detected, the receiver 104 decodes 124 the lost packets using the associated parity packets. If the receiver 104 is successful, the receiver 104 essentially restores the video stream, which can be sent to a video sink 126, such as a display or memory. If the receiver 104 is unsuccessful, the receiver 104 waits for more parity packets to arrive before attempting recovery of the lost packets. Methods for restoring the video stream by checking for lost packets 122 and decoding lost packets from associated parity packets 124 as performed by the receiver 104 are described in greater detail below. The receiver 104 also sends feedback 128 to the sender 102 regarding packet reception at the receiver 104. The feedback 128 indicates whether a packet is received, lost, or recovered and can be used by the sender 102 to adapt the method of encoding the parity packets as described in greater detailed below, or the sender 102 can use the feedback to resend lost video frame packets.

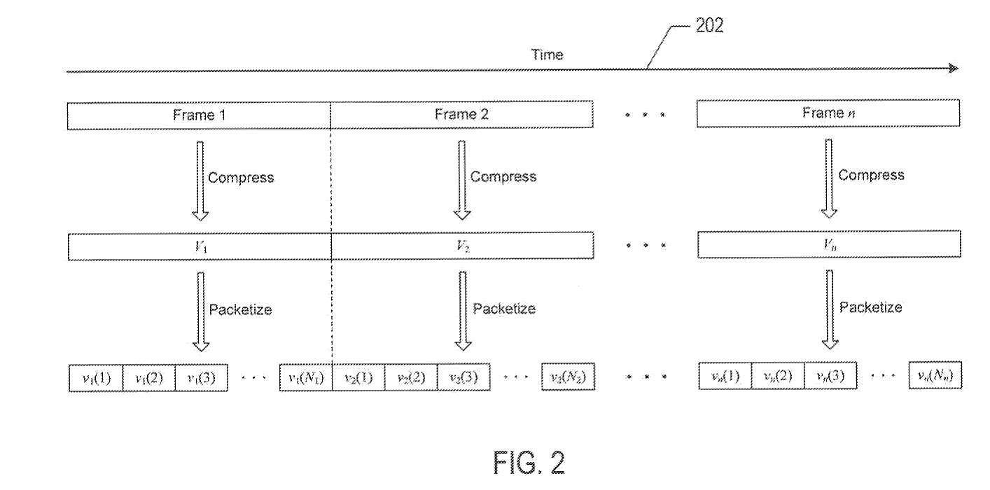

FIG. 2 represents the compression 108 and packetization 110 operations performed by the sender 102 on the video stream received from the video source 106. In the example of FIG. 2, directional arrow 202 represents progression of time. The video stream received by the sender 102 is composed of a series of video frames, three of which are denoted as Frame 1, Frame 2, and Frame n, where n is a positive integer that represents the nth video frame of the video stream. Larger values of n represent video frames that are received later in time, and smaller values of n represent video frames received early in time with n=1 corresponding to the first frame. As each frame is received by the sender 102, the frame is compressed to reduce the amount of data used to represent the frame. Compressed video frames are represented by Vₙ. Compression can be a combination of temporal motion compensation and spatial image compression. The frames can be compressed using interframe compression or intraframe compression. Interframe compression uses at least one of the earlier encoded frames in a sequence of frames to compress the current frame, while intraframe compression compresses only the current frame. Examples of video compression standards for performing video compression include, but are not limited to, MPEG-2. MPEG-4, and H.264. After each frame is compressed, each compressed video frame is packetized into a set of video frame packets:

$${V}_{n} {->}^{packetize} \{ {v}_{n} ( 1 ) , {v}_{n} ( 2 ) , {v}_{n} ( 3 ) , … , {v}_{n} ( {N}_{n} ) \}$$

where
vₙ(•) represents a video frame packet of the Vₙ compressed video frame, and
Nₙ represents the number of packets associated with the n^{th} frame.
   Each video frame packet vₙ(•) includes a header and a payload. The header identities the sender 102, the receiver 104 and includes information about the payload, and the payload is composed of image data associated with the frame.

Referring again to FIG. 1A, the method used by the sender 102 to encode 111 parity packets is based on an adaptable sliding window, forward error correction (“FEC”) coding scheme. Methods include adapting the sliding window of a FEC code based on the encoding algorithm and compression dependencies of the compressed video frames to increase the speed and efficiency of decoding the video stream. A video frame can be compressed using different encoding algorithms that are focused primarily on the amount of data compression associated with each frame. The three primary compressed frame types typically used in the video encoding algorithms are identified as intra-coded, predicted, and bi-predicted. Intra-coded frames are the least compressible frames and do not require other video frames to be decoded. In other words, an intra-coded frame is a fully-specified frame analogous to a static image. When all the packets of an intra-coded frame are received, a correct image can be decoded regardless of reception status of packets associated with previously received frames. Predicted frames can use data from previous frames to decompress and are more compressible than intra-coded frames, because predicted frames often hold only the changes in the image from the previous frame. For example, in a scene where an object moves across a stationary background, only the object's movements are encoded in the predicted frames. The encoder does not have to repeatedly store the unchanging background pixel information in the predicted frame, which results in a storage space savings. In contrast to an intra-coded frame, it is not sufficient to guarantee correct decoding of an image when the packets of a predicted frame are received. Instead, prior dependencies should also be received. Of special interest is a method to generate predicted frames that have substantially the same desirable robust properties of an intra-coded frame, but with better compression performance. Specifically, in a video streaming system with delayed feedback where the encoder keeps a list of previous frames, a predicted frame can be predicted from the previous frame that is known to have been correctly decoded by the receiver 104. Such a scheme, commonly referred to as Reference-Picture-Selection in H.263, or NewPred in MPEG-4, enables predicted frames to have substantially the same robustness as an intra-coded frame and are referred to as “robust predicted frames”. Bi-predicted frames can use both previous and forward frames for data reference to get the highest amount of data compression and saves more space than a predicted frame by using differences between the current frame and both the preceding and following frames to specify the current frame's content. Because the use of future frames for video frame prediction creates additional buffering delay before compression, bi-predicted frames are typically not employed in low-delay applications like video conferencing.

Note that when the receiver 104 receives intra-coded frames and robust predicted frames, the receiver 104 can get a fresh start by ignoring previously lost packets and is able to produce images for future predicted frames. In other words, intra-coded and robust predicted frames prevent error propagation. As a result, these frames mark a boundary in the relative importance of coded video frames. Specifically, irrecoverable loss of frame preceding an intra-coded frame or a robust predicted frame results in the loss of only one image. Similarly, the irrecoverable loss of the second frame preceding an intra-coded or robust predicted frame results in in the loss of only two images. In contrast, the predicted frames after an intra-coded or robust predicted frame are generally needed for all future frames until the next intra-coded or robust predicted frame. In other words, it can be advantageous to provide more protection for frames after an intra-coded or robust predicted frame than for preceding frames.

In some compression standards, such as H.264, different parts of a frame can optionally be predicted based on a different previous frame. When such options are employed, a single intra-coded frame or robust predicted frame reduces, but does not entirely eliminate all error propagation. The frames after an intra-coded frame and a robust predicted frame are still relatively more important than the preceding frames and should be protected accordingly.

In one common method, parity packets are generated as byte-wise (or symbol-wise) weighted linear sums of a set of video frame packets. For example, a parity packet is obtained from a window of W packets:

$$Parity\_packet = {\sum }_{i = 1}^{W} {α}_{i} {Packet}_{i} \qquad Equation 1$$

where αᵢ is an integer chosen from a finite field, and

Packetᵢ is a video frame packet selected from at least one set of video frame packets.

The set of {αᵢ} is generally different for different parity packets, and generation of multiple parity packets can be represented by a matrix notation. For example, generating three parity packets based on W packets is represented by

$$[ \begin{matrix}{Parity\_packet}_{1} \\ {Parity\_packet}_{2} \\ {Parity\_packet}_{3}\end{matrix} ] = [ \begin{matrix}{α}_{1 , 1} & {α}_{1 , 2} & {α}_{1 , 3} & … & {α}_{1 , W} \\ {α}_{2 , 1} & {α}_{2 , 2} & {α}_{2 , 3} & … & {α}_{2 , W} \\ {α}_{3 , 1} & {α}_{3 , 2} & {α}_{3 , 3} & … & {α}_{3 , W}\end{matrix} ] [ \begin{matrix}{Packet}_{1} \\ {Packet}_{2} \\ {Packet}_{3} \\ ⋮ \\ {Packet}_{W}\end{matrix} ]$$

Generally, when a particular αᵢ is zero, the parity packet contains no information about the packet Packetᵢ, and cannot be used to recover Pucketᵢ in the event it is lost. However, when αᵢ is zero, the single parity packet above can be used to recover Packetᵢ₊₁ even if the packets Packetᵢ and Packetᵢ₊₁ are both lost. In other words, preferential protection of packets can be achieved by eliminating dependencies (i.e., zeroing the corresponding coefficient α) on less important packets.

In general, parity packets can be generated using a non-linear generator function G(•):

Parity_packet=G(Packet₁, Packet₂, . . . , Packet_{W})

Preferential protection of packets can be similarly realized by choosing a G(•) that eliminates dependencies on less important packets. Such dependencies can be represented with a “generator dependency matrix,” with entries “0” representing non-dependency and “x” representing dependency. For example, when a parity packet depends on of the W packets, Packet₁, Packet₂, . . . . Packet_{W}, the parity packet can be written in matrix form as

$$Parity\_packet = [ \begin{matrix}x & x & x & … & x\end{matrix} ] [ \begin{matrix}{Packet}_{1} \\ {Packet}_{2} \\ {Packet}_{3} \\ ⋮ \\ {Packet}_{W}\end{matrix} ] \qquad Equation 2$$

Similarly, for the generation of three parity packets, Parity_packet₁, Parity_pucket₂, Parity_packet₃, where Parity_packet₂ does not depend on Packet₂, and Parity_packet₃ does not depend on Packet₂:

$$[ \begin{matrix}{Parity\_packet}_{1} \\ {Parity\_packet}_{2} \\ {Parity\_packet}_{3}\end{matrix} ] = [ \begin{matrix}x & x & x & … & x \\ 0 & x & x & … & x \\ x & 0 & x & … & x\end{matrix} ] [ \begin{matrix}{Packet}_{1} \\ {Packet}_{2} \\ {Packet}_{3} \\ ⋮ \\ {Packet}_{W}\end{matrix} ] \qquad Equation 3$$

The generator dependency matrix only represents the dependency or non-dependency of a parity packet on video packets, but does not fully specify the exact dependency. The determination of a set of video packets for generation of parity packets based on video compression dependency is the methods described herein.

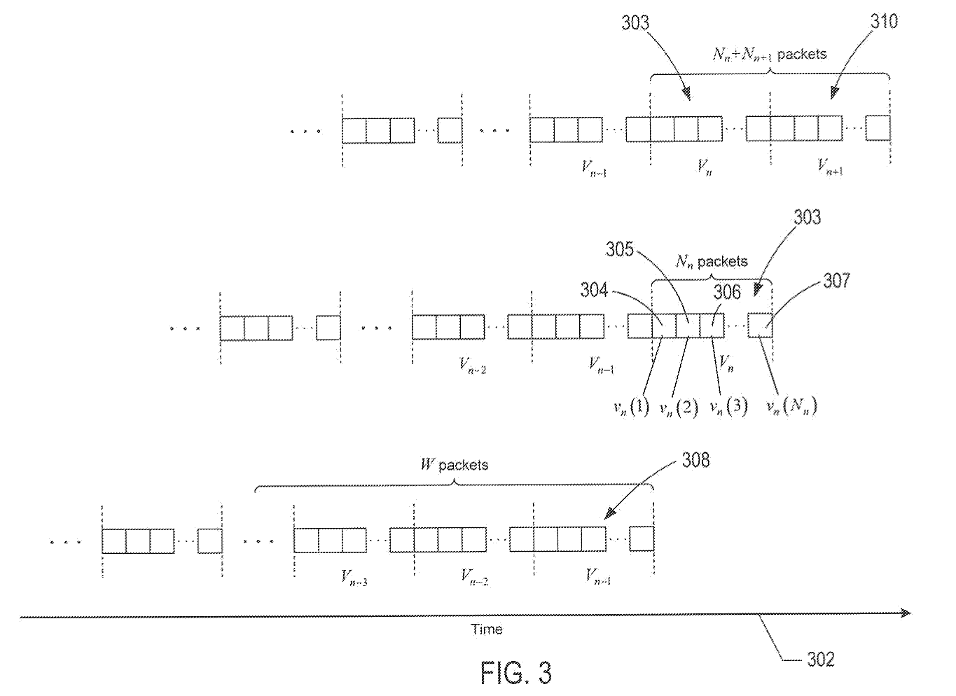

FIG. 3 shows an example of an adaptable sliding window associated with three consecutive compressed video frames Vₙ₋₁, . . . , Vₙ, and Vₙ₊₁. Directional arrow 302 represents the progression of time. Compressed video frames are separated by dashed lines, and the video frame packets of each compressed video frame are represented by blocks. For example, the Nₙ video frame packets vₙ(1), vₙ(2), vₙ(3), . . . , vₙ(Nₙ) of compressed video frame Vₙ 303 are represented by blocks 304-307, respectively. The adaptable sliding window represented in FIG. 3 is composed of a positive integer number of video frame packets. The window of video frame packets is referred to as adaptive, because the amount of video frame packet information associated with the most recent in time compressed video frame changes based on the type of the video frame. For example, suppose compressed video frame Vₙ₋₁ 308 is a predicted frame and the preceding frames are predicted frames so that the full or maximum sliding window W of present and past packet information can be used to encode the video frame packets of the frame Vₙ₋₁ 308. In other words, the sliding window associated with compressed video frame Vₙ₋₁ 308 is composed of the Nₙ₋₁ packets of the frame Vₙ₋₁ and W−Nₙ₋₁ video frame packets of past consecutive predicted frames. The next compressed video frame Vₙ 303 is an intra-coded frame. As a result, the sliding window is partitioned into two parts. The first part includes only the packets associated with the frame Vₙ 303, and these packets are used to generate parity packets for frame Vₙ. The second part contains W−Nₙ video packets that are not used to generate parity packets for frame Vₙ. With this technique, preferential protection of packets in the intra-coded frame is provided at the expense of earlier frames by not protecting packets of previous frames. Alternatively, portions or subsets of the second part of the sliding window, i.e., portions or subsets of the W−Nₙ video packets, are also used to generate parity packets for frame Vₙ. For example, a parity packet can be generated using video frame packets at or after the intra-coded frame, but only every other packet before the intra-coded frame. This offers preferential protection for the intra-coded frame, but also some protection for earlier packets. Specifically, the parity packet can recover loss of the packet vₙ(1) even if there are other losses in previous packets that are not used to compute the parity packet. By contrast, a single parity packet generated from a full window can only recover vₙ(1) if there are no other losses in the window.

The next compressed video frame Vₙ₊₁ 310 is a predicted frame, and therefore, depends primarily on the intra-coded frame Vₙ 303. As a result, the sliding window is partitioned so that the first part includes only the video frame packets of the current frame Vₙ₊₁ 310 and the video frame packets of the preceding frame Vₙ 303, and the second part contains W−(Nₙ+Nₙ₊₁) packets that are not used to generate parity packets for frame Vₙ₊₁. Alternatively, portions or subsets of the W−(Nₙ+Nₙ₊₁) video frame packets of past consecutive predicted frames are also used to encode the parity packets for frame Vₙ₊₁.

For both strategies described above, the methods adopted for preferential packet protection are described as follows. An intra-coded or robust predicted frame marks the boundary for generation of parity packets. Parity packets are generated with dependency on packets for frames at or after the intra-coded or robust predicted frame, but with sparse (partly or wholly zero) dependencies for packets before the intra-coded or robust predicted frame. In addition to relying on boundaries marked by intra-coded or robust predicted frames, as outlined above, an alternative method to determine the set of packets for generation of parity packets can be obtained by an optimization procedure as follows. For example, in one embodiment, suppose the sender 102 is currently transmitting video frame K and is generating the L^{th} parity packet. The distortion can be estimated as:

$${D}_{K} = {\sum }_{π ∈ Π} {d}_{K} ( π ) p ( π \vert {G}_{L} , {G}_{L - 1} , … , {G}_{1} )$$

where

D_{K} is the expected distortion for frame K,

π is the set of packets available for decoding after recovery attempts and depends on network conditions, protection offered by past parity packets, and possibly other employed recovery mechanism such as retransmission,

Π is the set of all possible π,

d_{K}(π) is the distortion of frame K given for the set of available packets π,

Gᵢ is the generator function of the i^{th} parity packet, and

p(π|G_{L}, G_{L-1}, . . . , G₁) is the conditional probability of receiving the set of packets π given parity packets are generated using G_{L}, G_{L-1}, . . . , G₁ and any feedback information. In particular, an optimal generator function G_{L}* can be computed as one that minimizes the distortion for the current frame K:

$$\begin{matrix}{G}_{L}^{*} = {argmin}_{{G}_{L}} {D}_{K} \\ = {argmin}_{{G}_{L}} {\sum }_{i} d ( {π}_{i} ) p ( {π}_{i} \vert {G}_{L} , {G}_{L - 1} , … , {G}_{1} )\end{matrix}$$

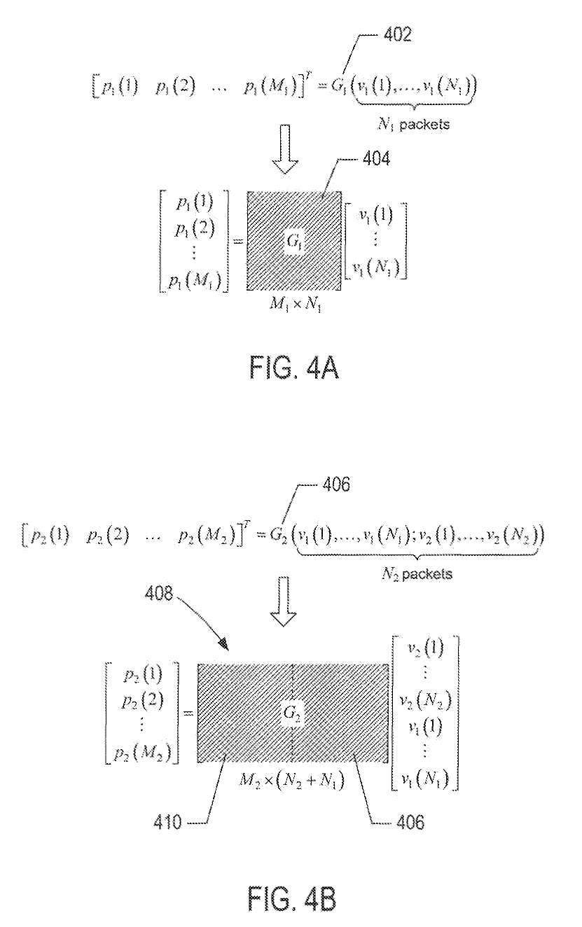

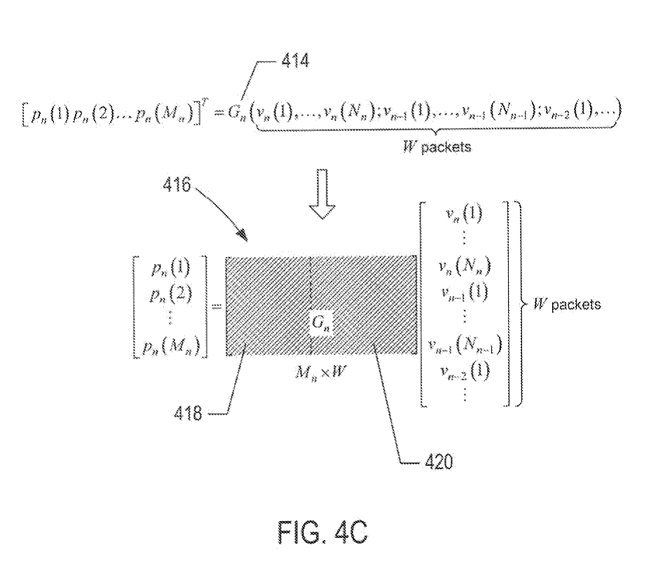

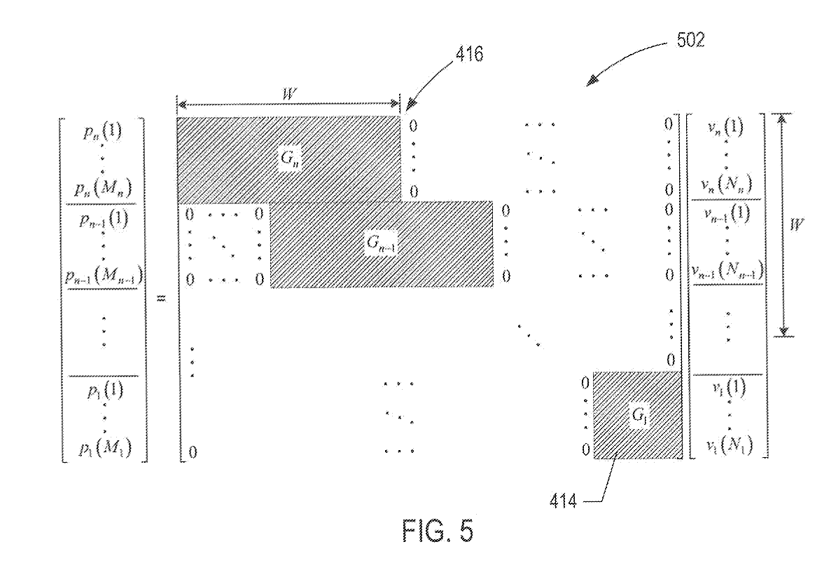

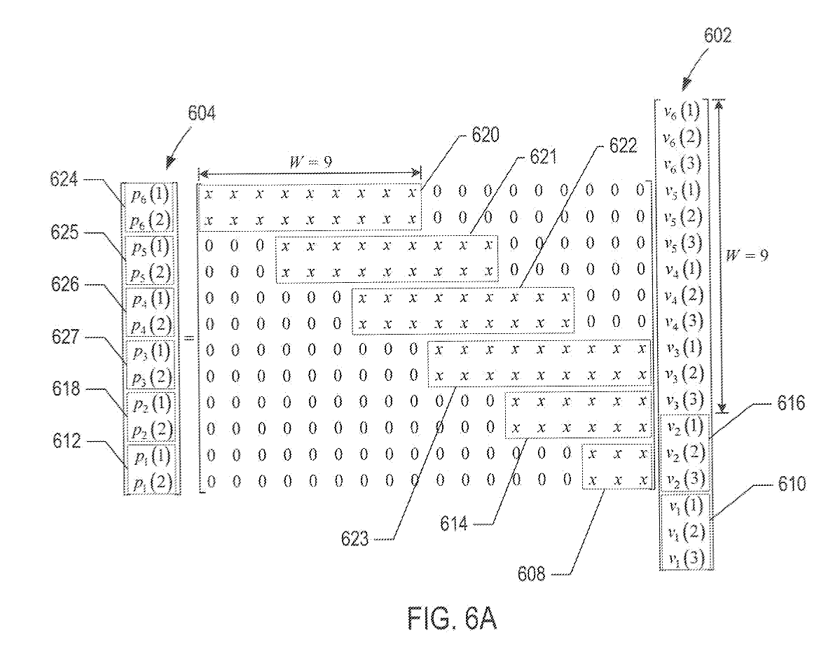

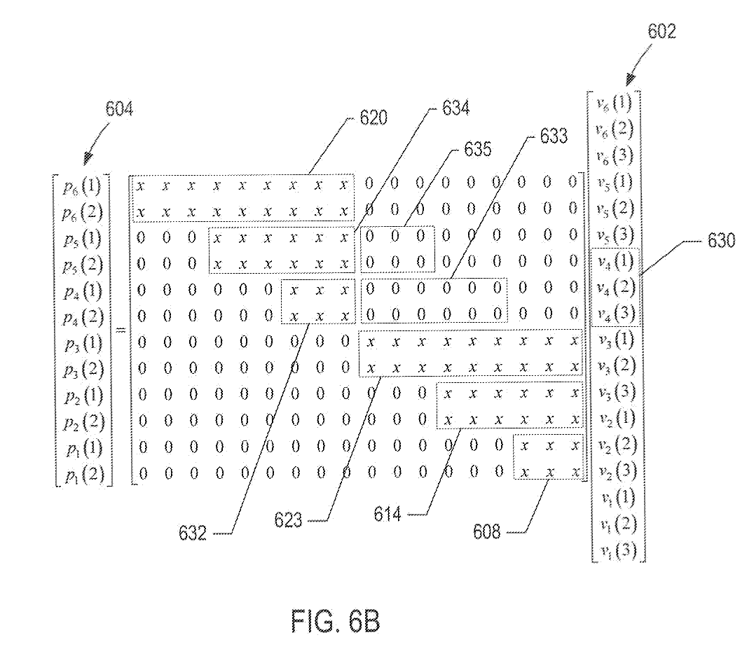

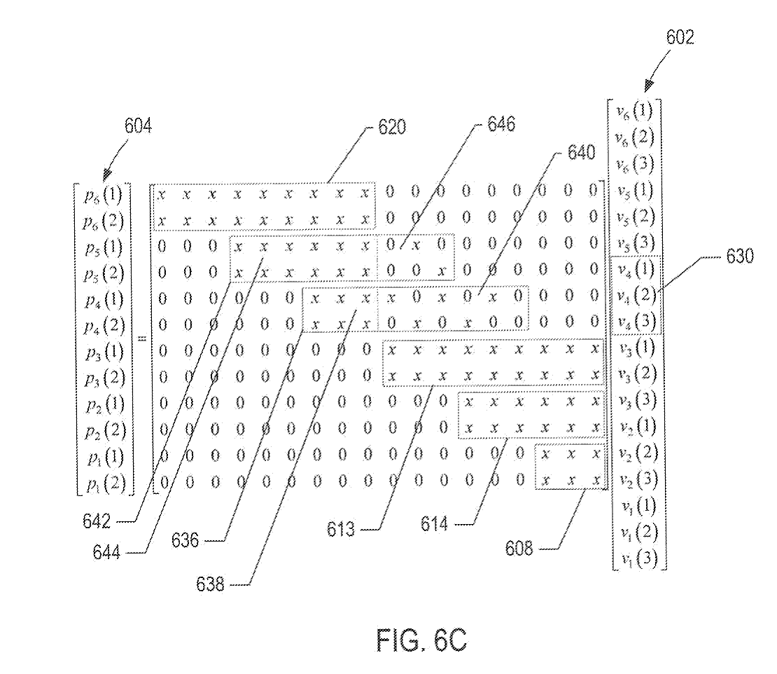

Examples of generating parity packets for a sliding window are described below with reference to FIG. 6, but consider first with reference to FIGS. 4 and 5 a special case where linear functions are used to generate parity packets. For each compressed video frame, the sliding window is adapted to encode a set of Mₙ parity packets, where Mₙ is a positive integer that represents the number of parity packets. Generator functions receive as input a window of video frame packets associated with a compressed video frame and outputs a set of Mₙ parity packets. FIGS. 4A-4C show examples of mathematical representations of sets of parity packets encoded with an adaptable sliding window. For simplicity, the case where frames preceding an intra-coded frame are considered less important is described, and only linear generator functions are considered. For linear generator functions, parity packets are generated according to Equation 1, with the matrix elements {α_{i,j}} chosen from a suitable matrix, such as a parity generation matrix of a Reed-Solomon code, a Cauchy matrix, a Hilbert matrix, a random matrix. In FIGS. 4A-4C, the video frame packets are arranged into a column vector. Each row of a generator matrix performs a linear operation on the packets or a column vector of video frame packets to produce one of Mₙ corresponding parity packets represented in a column vector. In FIG. 4A, the first compressed video frame V₁ of a video stream is an intra-coded frame, and therefore, has fewer associated video frame packets than the maximum sliding window of size W. Generator function G₁ 402 produces parity packets using the N₁ video frame packets of frame V₁ with a window of N₁ (N₁<W) video frame packets. The generator function G₁ 402 is also represented by an M₁×N₁ generator matrix 404. In FIG. 4B, the generator function G₂ 406 encodes a window of N₂+N₁ (N₂+N₁<W) video frame packets. The generator function G₂ 406 is represented by an M₂×(N₂+N₁) generator matrix 408. The generator matrix 408 is partitioned into a first submatrix 410 and a second submatrix 412. The first submatrix 410 operates on the video frame packets of the video frame V₂ and the second submatrix 412 operates on the video frame packets of the video frame V₁. The sparsity of the submatrix 412 is determined by the type or importance of frame V₂. For example, if video frame V₂ is an intra-coded frame with no dependence on frame V₁, the elements of submatrix 412 can be zeroes. If frame V₂ depends on previous frame V₁, the elements of submatrix 412 are not all zeroes and the sparsity of submatrix 412 is determined by the amount of dependence frame V₂ has on the previous frame V₁. In FIG. 4C, frame n−1 is intra-coded, but frame n is predictively coded. The generator function Gₙ 414 can encode the full sliding window of W video frame packets. The generator function Gₙ 414 is represented by an Mₙ×W generator matrix 416 and is partitioned into a first submatrix 418 and a second submatrix 420. The first submatrix 418 operates on the video frame packets of the video frame Vₙ and Vₙ₋₁, and the second submatrix 420 operates on the W−Nₙ−Nₙ₋₁ video frame packets of the preceding video frames. The submatrix 420 can be a zero matrix to maximize the chance that future video frames are decodable. Conversely, 420 can be a sparse but non-zero matrix to provide some, though reduced, protection to frames preceding the intra-coded frame. In other words, the sparsity of the generator matrices 408 and 416 can be used to protect the video information of previous frames used to encode the current video frame, based on the amount of dependence the current frame has on the video information contained in the previous frames.

FIG. 5 shows a general representation of a generator matrix in which the generator matrices of FIG. 4 are submatrices. The generator submatrices, including submatrices 406 and 414 are located along the diagonal of larger matrix 502 and are surrounded by zero entries. The adaptive sliding window is determined by the video frame compression.

FIGS. 6A-6C show three different examples of using a general generator and an adaptable sliding window that can be partitioned according to the compression dependence of the frame. For general generator functions, a generator dependency matrix is used to mark the dependency of each parity packet on each video packet with “0” indicating no dependency and “x” indicating dependency. In FIGS. 6A-6C, first six compressed frames V₁, . . . V₆ of a video stream each have three associated video frame packets represented in column vector 602. The generator dependency matrices include generator dependency submatrices located along the diagonal. Each generator dependency submatrix indicates the dependency of two parity packets on individual video frame packets. In FIG. 6A, generator dependency submatrix 608 indicates that parity packets 612 depend on all video frame packets 610 of a first intra-coded frame V₁, as represented by Equation 2. A generator dependency submatrix 614 shows that parity packets 618 are generated using past video frame packets 610 and video frame packets 616 of predicted frame V₂. Generator dependency submatrices 620-623 have the full sliding window of 9 packets, indicating that parity packets 624-627 are generated using their respective most recent 9 video packets. FIG. 6A represents a known application of sliding window FEC without regard to the dependencies of the video frames.

FIGS. 6B and 6C represent adaptation of the sliding window to address intra-coded frames and frames that can depend on one or more previous frames as represented by Equation 3. In FIG. 6B, the fourth compressed frame V₄ with video frame packets 630 is an intra-coded frame. As a result, the generator dependency submatrix associated with the frame V₄ is partitioned into a first submatrix 632 with a window size of 3 packets for the three video frame packets of intra-coded frame V₄ and a second submatrix 633 with zero-value matrix elements. The frame V₅ is a predicted frame. As a result, generator submatrix is partitioned into a first submatrix 634 indicating that the parity packet is generated using the video frame packets of frames V₄ and V₅ and a second submatrix 635 with zero-value matrix elements to indicate that the parity packet does not depend on video frame packets of V₃ and earlier frames. This is because V₅ depends on V₄, but not on previous frames. In FIG. 6C, frame V₄ has parts that are intra-coded and parts with compression dependency on frame V₃. As a result, the generator dependency submatrix 636 is partitioned into a first submatrix 638 that indicates the parity packet is generated with dependency on the video frame packets of the frame V₄ and a sparse submatrix 640 indicates that the parity packet only depends on selected video frame packets of preceding frames V₃ and V₂. Frame V₅ depends on frames V₄, which in turn has parts that depend on frame V₃. As a result, generator dependency submatrix 642 is partitioned into a first submatrix 644 for the video frame packets of frames V₅ and V₄ and a second sparse submatrix 646 for the video frame packets of frame V₃.

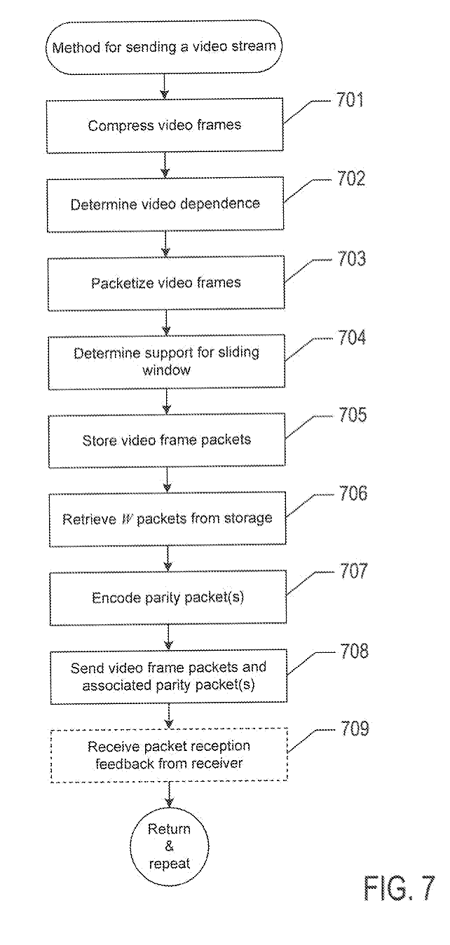

FIG. 7 shows a control-flow diagram of an example method for sending a video stream from the sender 102 to the receiver 104 described above with reference to FIG. 1. In block 701, the frames of a video stream received from a video source are compressed, as described above with reference to FIG. 2. In block 702, the video compression dependency of each frame is determined. For example, block 702 can include determining whether each frame is an intra-coded frame or a predicted frame, as described above. In block 703, the frames are packetized into video frame packets, as described above with reference to FIG. 2. In block 704, support for the sliding window is determined. Support for the sliding window is the set of packets that is used to generate a parity packet. For example, suppose there is no intra-coded frame or robust predicted frame within the last window of W video frame packets. Then in bock 704, the sliding window is set to the W most recent video frame packets as described above with reference to FIG. 6A. Also, suppose there is an intra-coded frame within a window of W video frame packets. Then in bock 704, the sliding window can be changed to match the number of video frame packets extended back to the intra-coded frame, as described above with reference to FIG. 6B. Alternatively, suppose the current frame is partly intra-coded, and has parts with compression dependency on earlier frames. Then in bock 704, the sliding window is changed to match the dependence on the video frame packets associated with the previous frame, as described above with reference to FIG. 6C. In block 705, the video frame packets are stored in memory. In block 706, the W video frame packets associated with each frame are retrieved from storage. In block 707, the W video frame packets retrieved storage are used to encode at least one parity packet, as described above with reference to FIG. 4. In block 708, the video frame packets and associated parity packets are sent to the receiver 104 over the at least one channel 114, as described above with reference to FIG. 1. In block 709, the sender 102 receives packet reception feedback from the receiver 104 indicated the state of the packets received by the receiver 104. The feedback can be used by the sender 102 to adapt the sliding window size or the sender 102 can use the feedback to resend lost video frame packets to the receiver 104.

Note that method embodiments are not intended to be limited to the arrangement of blocks shown in FIG. 7. For the sake of brevity, the method shown in FIG. 7 represents just one possible arrangement of blocks that can be used by the sender 102 to execute adaptable sliding window-based error correcting codes as described herein. The method can be adjusted by arranging certain blocks in a different order without departing from the methods of adapting the size of the sliding window of sliding window-based error correcting codes. For example, block 710 can be executed anywhere in the method shown in FIG. 7.

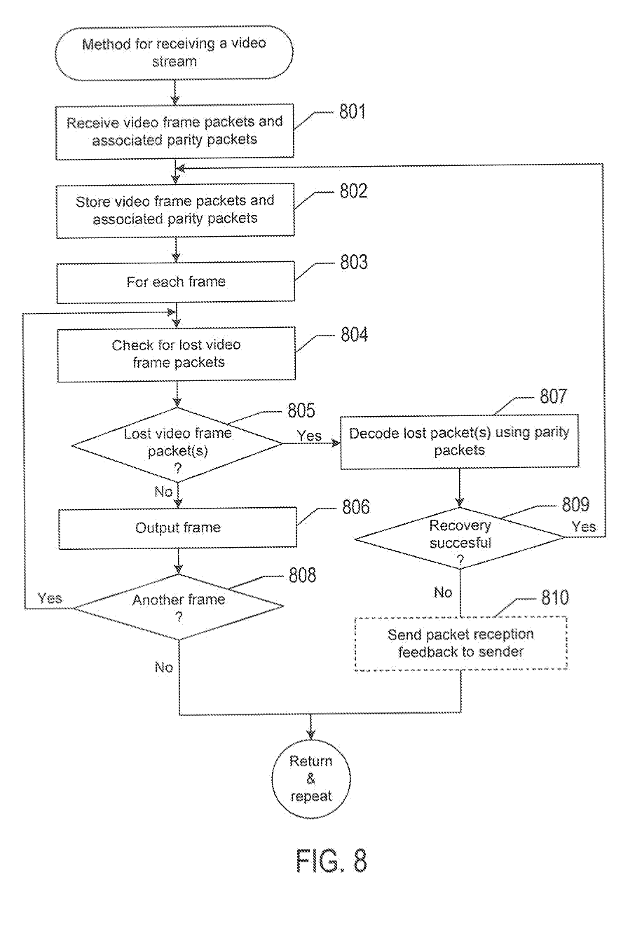

FIG. 8 shows a control-flow diagram of an example method for the receiver 104 to receive video frame packets from the sender 102 as described above with reference to FIG. 1. In block 801, the receiver 104 receives the video frame packets and associated parity packets over the channel 114, as described above with reference to FIG. 1. In block 802, the video frame packets and associated parity packets are stored in memory. In the for loop beginning with block 803, the operations of blocks 804-808 are repeated are repeated for each frame. In block 804, the video frame packets of each frame checked for any lost packets. In block 805, when it is determined that no video frame packets are lost, the method proceeds to block 806, otherwise, if at least one video frame packet is lost, the method proceeds to block 807. In block 806, the video frame packets are output, such as to a display, stored in memory, or sent to a destination over the Internet. In block 808, when more video frame packets associated subsequent frames are received the method proceeds returns to repeat blocks 804-807. In block 807, the parity packets are used to decode the at least one lost packets. In block 809, when the lost packets are successfully recovered from block 807, the method proceeds to block 802, otherwise, the method proceeds to block 810. In block 810, packet reception feedback is sent to the sender 102 indicated that the video frame packets associated lost and unrecoverable packets have to be resent.

The sender 102 that executes the methods for adapting the sliding window of sliding window-based error correcting codes based on the coding structure of a compressed video stream can be a computing device. The computing device can be a desktop computer, a laptop, a blade server or any other suitable device configured to carry out video and image processing.

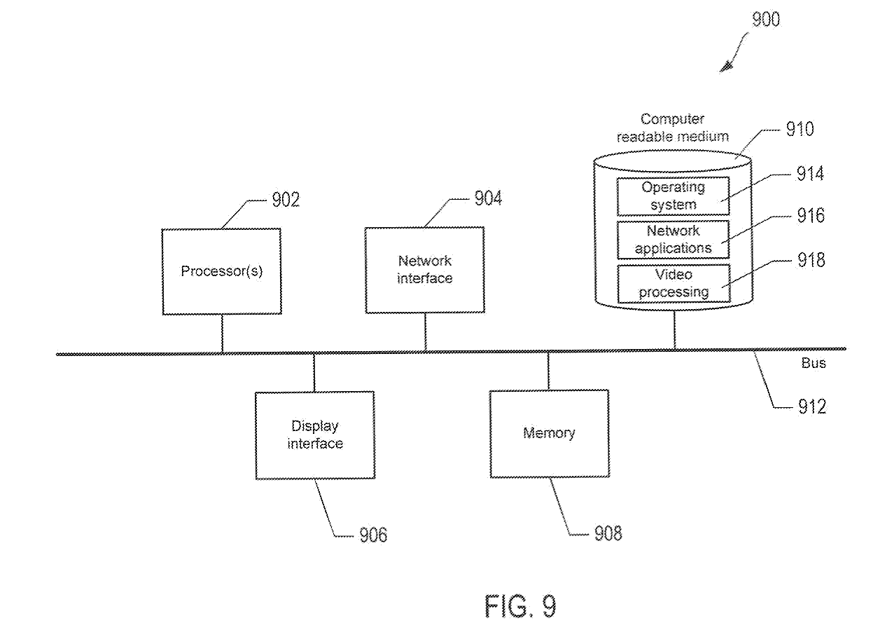

FIG. 9 shows a schematic representation of a computing device 900. The device 900 may include one or more processors 902; one or more a network interfaces 904, such as a Local Area Network LAN, a wireless 802.11x LAN, a 3G mobile WAN or a WiMax WAN; a display interface 906; memory 908; and one or mare computer-readable mediums 910. Each of these components is operatively coupled to one or more buses 912. For example, the bus 912 can be an EISA, a PCI, a USB, a FireWire, a NuBus, or a PDS.

The computer readable medium 910 can be any suitable medium that participates in providing instructions to the processor(s) 902 for execution. For example, the computer readable medium 910 can be non-volatile media, such as firmware, an optical disk, flash memory, a magnetic disk, or a magnetic disk drive; and volatile media, such as memory. The computer readable medium 910 can also store other software applications, including word processors, browsers, email, Instant Messaging, media players, and telephony software.

The computer-readable medium 910 may also store an operating system 914, such as Mac OS, MS Windows, Unix, or Linux; network applications 916; and a video-processing application 918. The operating system 914 can be multi-user, multiprocessing, multitasking, multithreading, real-time and the like. The operating system 914 can also perform basic tasks such as recognizing input from input devices, such as a keyboard, a keypad, or a mouse; sending output to the network; keeping track of files and directories on medium 910; controlling peripheral devices, such as disk drives, printers, image capture device; and managing traffic on the one or more buses 912. The network applications 916 includes various components for establishing and maintaining network connections, such as software for implementing communication protocols including TCP/IP, HTTP, Ethernet, USB, and FireWire.

The video-processing application 918 provides various machine readable instruction components for adapting the sliding window of sliding window-based error correcting codes based on the coding structure of a compressed video stream, as described above. In certain embodiments, some or all of the processes performed by the application 918 can be integrated into the operating system 914. In certain embodiments, the processes can be at least partially implemented in digital electronic circuitry, or in computer hardware, or in any combination thereof.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. A method for sending a media stream from a sender to a receiver, for each frame of the stream the method comprises:
packetizing the frame into packets;
determining compression dependence of the frame;
adapting a sliding window of a sliding window-based error correcting code based on the compression dependence of the frame;
encoding the packets of the frame into at least one associated parity packet according to the error correcting code with the adapted sliding window; and
sending the packets and the at least one associated parity packet to the receiver.

2. The method of claim 1, wherein the media stream is a video stream.

3. The method of claim 1, wherein determining compression dependence of the frame further comprises determining whether the frame is an intra-code frame.

4. The method of claim 1, wherein determining compression dependence of the frame further comprises determining whether the frame is a predicted frame or a robust predicted frame.

5. The method of claim 1, wherein determining compression dependence of the frame further comprises determining whether the frame is partially dependent on preceding frames.

6. The method of claim 1, wherein adapting the sliding window further comprises selectively choosing a non-continuous subset of past packets for generation of parity packets.

7. The method of claim 1, wherein adapting the sliding window further comprises partitioning the sliding window into a first part and a second part, the first part to include video frame packets of recent frames up to and including a previous intra-coded frame dr a previous robust predicted frame and the second part to include frame packets of a number of preceding frames.

8. The method of claim 7, wherein the second part is excluded from generation of a parity packet.

9. The method of claim 7, wherein a portion of the frame packets from the second part are used to generate a parity packet.

10. The method of claim 1 further comprising storing the frame packets.

11. A computer readable medium having instructions encoded thereon to direct at least one processor of a sender of a media stream to perform for each frame of the stream:
packetizing the frame into packets;
determining compression dependence of the frame;
adapting a sliding window of a sliding window-based error correcting code based on the compression dependence of the frame;
encoding the packets into at least one associated parity packet according to the error correcting code with the adapted sliding window; and
sending the packets and the at least one associated parity packet to the receiver.

12. The medium of claim 11, wherein the media stream is a video stream.

13. The medium of claim 11, wherein determining compression dependence of the frame further comprises determining whether the frame is an intra-code frame.

14. The medium of claim 11, wherein determining compression dependence of the frame further comprises determining whether the frame is a predicted frame or a robust predicted frame.

15. The medium of claim 11, wherein determining compression dependence of the frame further comprises determining whether the frame is partially dependent on preceding frames.

16. The medium of claim 11, wherein adapting the sliding window further comprises selectively choosing a non-continuous subset of past packets for generation of parity packets.

17. The medium of claim 11, wherein adapting the sliding window further comprises partitioning the sliding window into a first part and a second part, the first part to include video frame packets of recent frames up to and including a previous intra-coded frame or a previous robust predicted frame and the second part to include frame packets of a number of preceding frames.

18. The medium of claim 17, wherein the second part is excluded from generation of a parity packet.

19. The medium of claim 17, wherein a portion of the frame packets from the second part are used to generate a parity packet.

20. The medium of claim 11 further comprising storing the frame packets.
